(19) United States
(12) Patent Application Publication
(10) Pub. No.: US 2019/0375135 A1
(43) Pub. Date: Dec. 12, 2019

(54) LIGHT GUIDE PLATE WITH ANNULAR MICROPRISM STRUCTURES AND ITS MANUFACTURING METHOD

(71) Applicant: Shenzhen University, Shenzhen, Guangdong (CN)

(72) Inventors: Yanjun LU, Shenzhen, Guangdong (CN); Xiaoyu WU, Shenzhen, Guangdong (CN); Chaolan ZHOU, Shenzhen, Guangdong (CN); Wen WU, Shenzhen, Guangdong (CN); Guojing ZHANG, Shenzhen, Guangdong (CN)

(21) Appl. No.: 16/308,719

(22) PCT Filed: Jan. 30, 2018
(86) PCT No.: PCT/CN2018/074583

§ 371 Date: Dec. 10, 2018

(51) Int. Cl. B29C 33/38; F21V 8/00; B29D 11/00

(52) U.S. Cl. CPC B29C 33/3842; G02B 6/0038; B29K 2033/12; B29D 11/00663; B29K 2905/10; G02B 6/0065

(57) ABSTRACT

The present application provides a light guide plate with annular microprism structures and its manufacturing method. The method includes the following steps: A) processing a diamond turning tool of a desired shape according to a shape of a second annular microprism of a light guide plate to be processed; B) turning a surface of a light guide plate mold core by the diamond turning tool, and processing the surface of the light guide plate mold core to form first annular microgrooves, wherein a first annular microprism is formed between two adjacent first annular microgrooves; and C) feeding an acrylic powder material to the light guide plate mold core finished in step B) in an injection molding machine, and performing micro-injection molding to form a light guide plate with second annular microprisms. This application enhances the light brightness and the light uniformity of light guide plate, thereby improving the utilization efficiency of light, and the light guide plate mold core with the first annular microprism is processed by diamond turning, then the light guide plate with the second annular microprism is formed by micro injection molding. It makes the formed second annular microprism has more precise and controllable shape.

### TECHNICAL FIELD

The application relates to the technical field of light guide plates, and more particularly to a light guide plate with annular microprism structures and its manufacturing method.

### BACKGROUND

At present, LED side-lit illumination is often used for small and thin backlight modules, and the light guide plate is an indispensable part. The main function of the light guide plate is to convert the line source of the incident surface into a surface light source to be emitted from the emergent surface. Generally, a mesh dot is disposed on the lower surface of the light guide plate. When the light hits the mesh point on the light guide plate, the mesh point causes the incident light to be scattered and reflected along various directions, and finally is emitted from the emergent surface of the light guide plate. The dot design of traditional light guide plate has few types, and it is common to have a uniform dot arrangement or a dot gradually increasing or decreasing along a certain direction. Such a structure of the dot will make the divergence angle of the emitted light increase, resulting in waste of light energy and too large unevenness of the regional illuminance, so that the light guide plate cannot be better utilized.

In order to solve this problem, the light brightness and the light uniformity of the LED light guide plate can be increased by providing a microprism array structure on the emergent surface of the light guide plate. Conventionally, the microprism array structure on the emergent surface of the light guide plate is usually fabricated by an electrochemical etching machining such as laser beam processing or hot stamping technology. However, it cannot be used to machine a mirror surface with a high-precision shape, and the shape and size accuracy and processing quality of the microprism array structure processing cannot be ensured.

### Technical Problems

It is an object of the present application to provide a light guide plate with annular microprism structures and its manufacturing method, and to improve the existing problems of making microprism on the light guide plate by electrochemical etching machining. It can process mirror with high precision, and ensure the shape and size accuracy of microprism array structure and the technical problems of processing quality.

### Technical Solutions

In order to achieve the above object, the technical solution adopted by the present application is to provide a method for manufacturing a light guide plate with annular microprism structures, comprising the following steps:

A) processing a diamond turning tool of a desired shape according to a shape of a second annular microprism of a light guide plate to be processed;

B) turning a surface of a light guide plate mold core by the diamond turning tool, and processing the surface of the light guide plate mold core to form first annular microgrooves, in which a first annular microprism is formed between two adjacent first annular microgrooves; and

C) feeding an acrylic powder material to the light guide plate mold core finished in step B) in an injection molding machine, and performing micro-injection molding to form a light guide plate with second annular microprisms.

Further, step B) particularly comprises the following steps:

B1) mounting the diamond turning tool on a tool holder of a CNC (Computerized Numerical Control) turning machine, mounting the light guide plate mold core on a spindle of the CNC turning machine, and turning the surface of the light guide plate mold core by the diamond turning tool to form a first first annular microgroove;

B2) moving the diamond turning tool backwards in a normal direction with a first predetermined distance after the processing of the first first annular microgroove is completed, moving the diamond turning tool along a radial direction of the light guide plate mold core with a second predetermined distance, and causing the diamond turning tool to continue to turn the surface of the light guide plate mold core to form a second first microgroove; and

B3) repeating step B2) until the processing of a desired number of the first annular microgrooves is completed.

Further, the following step is comprised before step B1):

B0) designing a size of the light guide plate mold core according to size requirement of the light guide plate.

Further, in step B1), the spindle rotates at a rotational speed W, and the diamond turning tool 10 turns the surface of the light guide plate mold core with a normal feed depth a and a feed speed V; the rotational speed W of the spindle is 100 to 1000 rpm, the normal feed depth a of the diamond turning tool 10 is 0.5 to 5 μm, and the feed speed V of the diamond turning tool is 100 to 1000 mm/min.

Further, in the step B), the respective first annular microgroove has a depth of 10-500 μm, and a distance between the two adjacent first annular microgrooves is 10-500 μm.

Further, in the step B), the light guide plate mold core is made of a copper-aluminum alloy.

Further, in the step C), the light guide plate is made of a polymethyl methacrylate.

Further, the respective first annular microgroove has a V-shaped, U-shaped, or rectangular cross-sectional contour.

Further, the step A) particularly comprises: rotating the diamond turning tool 10 around a grinding wheel axis, grinding the diamond turning tool against a diamond dresser along a preset grinding path, and truing a cutting edge of the turning tool into a specific shape.

The present application further provides a light guide plate with annular microprism structures. The light guide plate is manufactured by the above-described method, and comprises a light incident surface and a light emergent surface. The light emergent surface defines therein a plurality of second annular microgrooves, with a second annular microprism being formed between two adjacent second annular microgrooves.

Further, the respective second annular microgroove has a V-shaped, U-shaped, or rectangular cross-sectional contour.

Further, the second annular microgrooves are concentrically arranged in circumferential directions of concentric circles with a same circle center, respectively, wherein the circle center being arranged in a center of the light emergent surface.

Further, a distance between the two adjacent of said second annular microgrooves is equal.

Further, the respective second annular microgroove has a depth of 10-500 μm, and a distance between the two adjacent second annular microgrooves is between 10-500 μm.

### Beneficial Effects

The light guide plate with the annular microprism structures and its manufacturing method provided by the present application have the following beneficial effects: as compared with the prior art, the light guide plate with the annular microprism structures and its manufacturing method provided by the present application adopt the diamond turning tool to turn the end face of the light guide plate mold core, such that the first annular microgrooves are processed on the end surface of the light guide plate mold core, and the first annular micro-prism is formed between the two adjacent first annular microgrooves, then, the processed light guide plate mold core is added with the acrylic powder material for injection molding, to manufacture the light guide plate with the second annular microprisms, so that the light brightness and the light uniformity of the light guide plate are enhanced, and the utilization efficiency of the light is improved. The present application uses the diamond turning technology to process the light guide plate mold core with the first annular microprisms, and then fabricates the light guide plate with the second annular microprisms by micro injection molding. The second annular microprisms on the formed light guide plate can be made to have high precision and controllable shape, and can realize mass production and manufacture of the light guide plate, thereby greatly reducing the manufacturing cost. Therefore, it is solved the technical problem in the prior art that the shape and size accuracy of the processing and the processing quality of the microprisms cannot be ensured because the microprisms of the light guide plate are manufactured by using an electrochemical etching machining, such as laser beam processing or hot stamping technology.

### BRIEF DESCRIPTION OF THE DRAWINGS

In order to more clearly illustrate the technical solutions in the embodiments of the present application, the drawings used in the embodiments or the prior art description will be briefly introduced below. Obviously, the drawings in the following description are only some embodiments of the present application, and other drawings may be obtained by those skilled in the art according to the drawings without any inventive labor.

FIG. 1 is a flowchart of a method for manufacturing a light guide plate with annular microprism structures provided with by one embodiment of the present application;

FIG. 2 is a specific flowchart of step S200 provided by one embodiment of the present application;

FIG. 3 a processing schematic view of a method for manufacturing a light guide plate with annular microprism structures provided by one embodiment of the application;

FIG. 4 is a schematic view of a light guide plate with annular microprism structures according to one embodiment of the present application; and

FIG. 5 is a sectional schematic view of a light guide plate with annular microprism structures according to one embodiment of the present application.

Among them, the following reference numerals are used in the figures:

10: Diamond turning tool; 20: Light guide plate mold core; 21: First annular microgroove; 22: First microprism; 30: Light guide; 31: Second annular microgroove; and 32: Second microprism.

### DETAILED DESCRIPTION OF THE EMBODIMENTS

The present application will be further described in detail below with reference to the accompanying drawings and embodiments. It should be understood that the specific embodiments described herein are merely intended to explain the application rather than to limit the present application.

It should be noted that when an element is referred to as being “fixed” or “arranged” at/in/on another element, it can be directly at/in/on the other element. When an element is referred to as being “connected” to/with another element, it can be directly or indirectly connected to/with the other element.

It should be understood that terms “length”, “width”, “upper”, “lower”, “front”, “rear”, “left”, “right”, “vertical”, “horizontal”, “top”, “bottom”, “inside”, “outside” and the like indicating orientation or positional relationship are based on the orientation or the positional relationship shown in the drawings, and are merely for facilitating and simplifying the description of the present application, rather than indicating or implying that a device or component must have a particular orientation, or be configured or operated in a particular orientation, and thus should not be construed as limiting the application.

Moreover, the terms “first” and “second” are adopted for descriptive purposes only and are not to be construed as indicating or implying a relative importance or implicitly indicating the number of technical features indicated. Thus, features defining “first” and “second” may include one or more of the features either explicitly or implicitly. In the description of the present application, the meaning of “a plurality of” or “multiple” is two or more unless otherwise particularly defined.

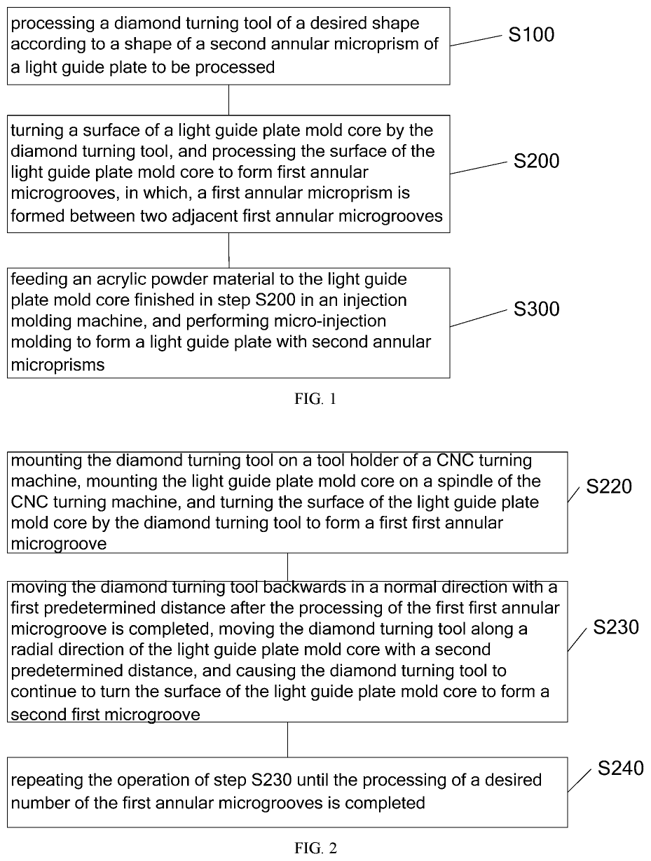

Referring to FIG. 1 to FIG. 5, a method for manufacturing a light guide plate with annular microprism structures provided by the present application is described hereinbelow. The method for manufacturing the light guide plate with the annular microprism structures comprises: steps S100, S200, and S300;

S100: processing a diamond turning tool 10 of a desired shape according to a shape of a second annular microprism 32 of a light guide plate to be processed.

The light guide plate mold core with the second annular microprisms arranged on the light guide plate can be designed by optical software to obtain optimal arrangement parameters of the second annular microprism.

S200: turning a surface of a light guide plate mold core 20 by the diamond turning tool 10, and processing the surface of the light guide plate mold core 20 to form first annular microgrooves 21, in which, a first annular microprism 22 is formed between two adjacent first annular microgrooves 21.

A plurality of the first annular microprisms form a first annular microprism array structure.

S300: feeding an acrylic powder material to the light guide plate mold core 20 finished in step S200 in an injection molding machine, and performing micro-injection molding to form a light guide plate with second annular microprisms.

The injection molding machine is a micro injection molding machine.

As compared with the prior art, the method for manufacturing a light guide plate with annular microprism structures provided by the present application adopts the diamond turning tool 10 to turn the end face of the light guide plate mold core 20, such that the first annular microgrooves 21 are processed on the end surface of the light guide plate mold core 20, and the first annular micro-prism 22 is formed between the two adjacent first annular microgrooves 21, then, the processed light guide plate mold core 20 is added with the acrylic powder material for injection molding, to manufacture the light guide plate 30 with the second annular microprisms 32. The second annular microprisms 32 can reduce the divergence angle of the emitted light, so that the light brightness and the light uniformity of the light guide plate are enhanced, and the utilization efficiency of the light is improved. The present application uses the diamond turning technology to process the light guide plate mold core with the first annular microprisms, and then fabricates the light guide plate 30 with the second annular microprisms 22 by micro injection molding. The second annular microprisms 22 on the formed light guide plate can be made to have high precision and controllable shape, and can realize mass production and manufacture of the light guide plate, thereby greatly reducing the manufacturing cost. Therefore, it is solved the technical problem in the prior art that the shape and size accuracy of the processing and the processing quality of the microprisms cannot be ensured because the microprisms of the light guide plate are manufactured by using an electrochemical etching machining, such as laser beam processing or hot stamping technology.

Further, referring to FIG. 2, as a specific embodiment of the method for manufacturing the light guide plate with the annular microprism structures, the above step S200 particularly includes steps S220, S230, and S240:

S220: mounting the diamond turning tool 10 on a tool holder of a CNC turning machine, mounting the light guide plate mold core 20 on a spindle of the CNC turning machine, and turning the surface of the light guide plate mold core 20 by the diamond turning tool to form a first first annular microgroove.

Particularly, in the above step S230, the spindle rotates at a rotational speed W, and the diamond turning tool 10 turns the surface of the light guide plate mold core 20 with a normal feed depth a and a feed speed V. The rotational speed W of the spindle is 100 to 1000 rpm, the normal feed depth a of the diamond turning tool 10 is 0.5 to 5 μm, and the feed speed V of the diamond turning tool 10 is 100 to 1000 mm/min.

S230: moving the diamond turning tool 10 backwards in a normal direction with a first predetermined distance after the processing of the first first annular microgroove 21 is completed, moving the diamond turning tool 10 along a radial direction of the light guide plate mold core 20 with a second predetermined distance, and causing the diamond turning tool 10 to continue to turn the surface of the light guide plate mold core to form a second first microgroove 20.

The “first preset distance” and the “second preset distance” may be set according to actual needs, for example, the second preset distance may be set to 10-500 μm.

S240: repeating the operation of step S230 until the processing of a desired number of the first annular microgrooves 21 is completed.

Further, as a specific embodiment of the method for manufacturing the light guide plate with the annular microprism structures, step S210 is further included before the step S200:

S210: designing a size of the light guide plate mold core 20 according to size requirement of the light guide plate 30.

The size of the light guide plate 30 is usually determined according to the size of the display screen, and then the size of the light guide plate mold core 20 is cut according to the size of the light guide plate 30, the arrangement density of the second annular microprisms 32 on the light guide plates 30 of different sizes is different. Particularly, in this embodiment, the light guide plate 30 has a cylindrical shape, and the light guide plate 30 has a surface diameter of 70 mm and a thickness of 3 mm.

Further, as a specific embodiment of the method for manufacturing the light guide plate with the annular microprism structures, step S201 is further comprised before step S210:

S201: plating a nickel layer on the surface of the light guide plate mold core.

By plating the nickel layer on the surface of the light guide plate mold core 20, it is possible to provide good strength and corrosion resistance.

Further, as a specific embodiment of a method for manufacturing the light guide plate with the annular microprism structures, the above step S100 particularly comprises: rotating the diamond turning tool 10 around a grinding wheel axis, grinding the diamond turning tool against a diamond dresser along a preset grinding path, and truing a cutting edge of the turning tool into a specific shape.

The diamond turning tool 10 having a specific shape of the cutting edge can be machined in step S100. For example, if a cross-sectional contour of the second annular microgroove 31 on the light guide plate 30 is V-shaped, the cutting edge of the diamond turning tool 10 needs to be processed into a V shape. The cross-sectional contour of the first annular microgroove processed by the diamond turning tool is V-shaped. An angle of the second annular microgroove 31 is 90°, and the angle of the cutting edge of the diamond turning tool 10 is 90°. It should be noted that the cross-sectional contour of the second annular microgroove 31 is not limited to the above shapes. For example, in other preferred embodiments of the present application, the second annular microgroove 31 has a U-shaped or rectangular cross-sectional contour, and when the cross-sectional contour of the second annular microgroove 31 is U-shaped, the cutting edge of the diamond turning tool has a U shape, and the processed first annular microgroove 21 has a U-shaped cross-sectional contour; and when the second annular microgroove 31 has a rectangular cross-sectional contour, The cutting edge of the diamond turning tool has a rectangular shape, and the processed first annular microgroove 21 has a rectangular cross-sectional contour.

Further, in the above step S300, the light guide plate 30 is made of a polymethyl methacrylate. The light guide plate mold core 20 is a copper alloy core. The diamond turning tool 10 is a single crystal diamond turning tool.

The light guide plate 30 after injection molding has second annular microgrooves 31, and a second annular microprism 32 is formed between every two adjacent second annular microgrooves 31. The shape, size, arrangement, and the like of the second annular microgrooves 31 are completely the same as the shape, size, arrangement, and the like of the first annular microgrooves 21. For example, the depth H of the second annular microgroove 31 is the same as the depth of the first annular microgroove 21, and the spacing D between two adjacent second annular microgrooves 31 and the pitch between two adjacent first annular microgrooves 21 is the same, and the shape of the second annular microgrooves 31 is the same as the shape of the first annular microgrooves 21. Preferably, a depth H of the second annular microgroove 31 is 10-500 μm, and a distance D between the two adjacent second annular microgrooves 31 is 10-500 μm.

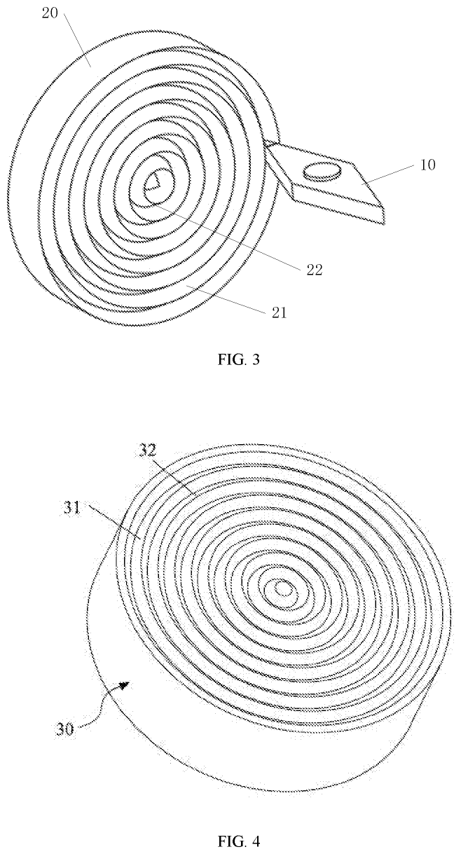

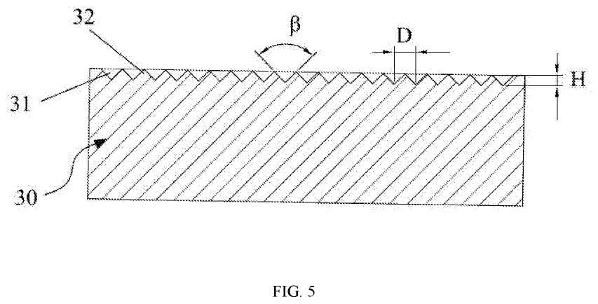

Referring to FIG. 3, FIG. 4, and FIG. 5, the present application further provides a light guide plate with annular microprism structures, which is manufactured by the above manufacturing method. The light guide plate 30 comprises a light incident surface and a light emergent surface, and the light emitting surface defines therein a plurality of second annular microgrooves 31. A second annular microprism 32 is formed between two adjacent second annular microgrooves 31.

Further, referring to FIG. 4 and FIG. 5, as a specific embodiment of the light guide plate with the annular microprism structures, the second annular microgrooves 31 are concentrically arranged in circumferential directions of concentric circles with a same circle center, respectively, wherein the circle center being arranged in a center of the light emergent surface. Preferably, the distance between the two adjacent second annular microgrooves 31 is equal, that is, the second annular microgrooves 31 are evenly arranged. It should be noted that the arrangement of the second annular microgrooves 31 is not limited thereto. For example, in other preferred embodiments of the present application, the second annular microgrooves 31 can also be distributed on the light emergent surface of the light guide plate 30 in a non-uniform arrangement, such that the divergence angle of the emitted light can be reduced, the illumination of the emitted light is enhanced, and the utilization efficiency of light is improved. For example, in one embodiment of the present application, the spacing between the second annular microgrooves 31 may gradually increase or decrease along the radial direction of the light emergent surface.

Further, referring to FIG. 4 and FIG. 5, as a specific embodiment of a light guide plate with annular microprism structures, a depth H of the second annular microgroove 31 is 10-500 μm, and a distance D between the two adjacent second annular microgrooves 31 is 10-500 μm.

Further, referring to FIG. 5, the second annular microgroove 31 has a V-shaped cross-sectional contour, and the second annular microgroove 31 has an angle β of 90°. It should be noted that the cross-sectional contour of the second annular microgroove 31 is not limited thereto. For example, in other preferred embodiments of the present application, the second annular microgroove 31 has a U-shaped or rectangular cross-sectional contour.

Further, an antireflection film is provided on the light incident surface and the light emitting surface.

The above is only the preferred embodiment of the present application, and is not intended to limit the present application, and any modifications, equivalent substitutions, and improvements made within the spirit and scope of the present application, all should be included in the scope of protection of the present application.

1. A method for manufacturing a light guide plate with annular microprism structures, comprising the following steps:
A) processing a diamond turning tool of a desired shape according to a shape of a second annular microprism of a light guide plate to be processed;
B) turning a surface of a light guide plate mold core by the diamond turning tool, and processing the surface of the light guide plate mold core to form first annular microgrooves, wherein a first annular microprism is formed between two adjacent first annular microgrooves; and
C) feeding an acrylic powder material to the light guide plate mold core finished in step B) in an injection molding machine, and performing micro-injection molding to form a light guide plate with second annular microprisms;
wherein step B) comprises the following steps:
B1) mounting the diamond turning tool on a tool holder of a computerized numerical control turning machine, mounting the light guide plate mold core on a spindle of the computerized numerical control turning machine, and turning the surface of the light guide plate mold core by the diamond turning tool to form a first first annular microgroove;
B2) moving the diamond turning tool backwards in a normal direction with a first predetermined distance after the processing of the first first annular microgroove is completed, moving the diamond turning tool along a radial direction of the light guide plate mold core with a second predetermined distance, and causing the diamond turning tool to continue to turn the surface of the light guide plate mold core to form a second first microgroove; and
B3) repeating step B2) until the processing of a desired number of the first annular microgrooves is completed.

2. (canceled)

3. The method of claim 1, further comprising the following step before step B1):
B0) designing a size of the light guide plate mold core according to size requirement of the light guide plate.

4. The method of claim 1, wherein in step B1), the spindle rotates at a rotational speed W, and the diamond turning tool turns the surface of the light guide plate mold core with a normal feed depth a and a feed speed V; the rotational speed W of the spindle is 100 to 1000 rpm, the normal feed depth a of the diamond turning tool 10 is 0.5 to 5 μm, and the feed speed V of the diamond turning tool is 100 to 1000 mm/min.

5. The method of claim 1, wherein in the step B), the respective first annular microgroove has a depth of 10-500 μm, and a distance between the two adjacent first annular microgrooves is 10-500 μm.

6. The method of claim 1, wherein in the step B), the light guide plate mold core is made of a copper-aluminum alloy.

7. The method of claim 1, wherein in the step C), the light guide plate is made of a polymethyl methacrylate.

8. The method of claim 1, wherein the respective first annular microgroove has a V-shaped, U-shaped, or rectangular cross-sectional contour.

9. The method of claim 1, wherein the step A) comprises: rotating the diamond turning tool around a grinding wheel axis, grinding the diamond turning tool against a diamond dresser along a preset grinding path, and truing a cutting edge of the turning tool into a specific shape.

10-14. (canceled)
